(19) United States
(12) Patent Application Publication
(10) Pub. No.: US 2016/0009053 A1
(43) Pub. Date: Jan. 14, 2016

(54) STRUCTURE OF MULTILAYER COMPONENT

(71) Applicant: CALSONIC KANSEI CORPORATION, Saitama-shi (JP)

(72) Inventors: Kenjiro Sugimoto, Saitama-shi (JP); Akira Saitou, Saitama-shi (JP)

(21) Appl. No.: 14/770,518

(22) PCT Filed: Feb. 24, 2014
(86) PCT No.: PCT/JP2014/054285

§ 371 Date: Aug. 26, 2015

(30) Foreign Application Priority Data
Feb. 27, 2013 (JP) 2013-036836
Jul. 3, 2013 (JP) 2013-139711

(51) Int. Cl. B32B 5/18; B32B 7/08

(52) U.S. Cl. CPC B32B 5/18; B32B 7/08; B32B 2605/003; B32B 2307/744

(57) ABSTRACT

A structure of a multilayer component in which a rigid core material, a soft surface material, and a cushioned foam layer provided between the core material and the surface material are integrated, wherein the core material includes an exposed core material portion without having the surface material and the form layer, the exposed core material portion is obtained by cutting off at least the surface material to be eliminated, and a cutting assist portion that projects toward the surface material or toward an opposite side of the surface material to assist cutting off with a cutting tool is provided in a part of the core material on which the surface material is cut off.

### TECHNICAL FIELD

This invention is concerning a structure of a multilayer component in which a surface material is appropriately cut off.

### BACKGROUND ART

A vehicle interior component such as an instrument panel is installed in a front part of a vehicle interior in a vehicle such as an automobile. Accessories, for example, a ventilator grille and a decoration panel that are structured as separate members are mounted on such an instrument panel. These accessories are mounted on an opening portion or a concave portion that is previously formed in a predetermined position of the instrument panel.

The vehicle interior component is structured by a multilayer component. The multilayer component includes a rigid core material, a soft surface material, and a cushioned foam layer provided between the core material and the surface material. These core material, surface material, and foam layer are integrated.

The vehicle interior component having such a structure of a multilayer component is manufactured by foam molding that injects foam liquid as a material of the foam layer between the core material and the surface material set in a foam molding die to mold the foam layer by foaming the foam liquid in the foam molding mold.

For forming the opening portion or the concave portion on which the above-described accessory is mounted in the vehicle interior component, an opening and concave portion formation predetermined portion without having the foam layer in a portion where the opening portion or the concave portion is formed, for example, a two-layer laminated portion having the core material and the surface material is formed in the foam molding, or an opening and concave portion formation predetermined portion in which a thickness of the foam layer in a portion where the opening portion or the concave portion is formed is thinner than that of the other portion, for example, a three-layer laminated portion having the core material, foam layer, and surface material is formed in the foam molding.

After the foam molding, the inside portion of the opening and concave portion formation predetermined portion is appropriately processed by using a cutting tool such as a hot blade to form an exposed core material portion.

The accessories are then mounted on the exposed core material portion.

More specifically, the opening portion, namely, a core material opening portion is formed inside the opening and concave portion formation predetermined portion by penetrating the two-layer laminated portion having the core material and the surface material or the three-layer laminated portion having the core material, foam layer, and surface material inside the opening and concave portion formation predetermined portion with the cutting tool such as the hot blade.

After that, the exposed core material portion is formed by trimming the surface material and the foam layer to leave only the core material with the cutting tool such as the hot blade between a circumference edge portion of the core material opening portion and a circumference edge portion of the opening and concave portion formation predetermined portion. This exposed core material portion is used as a standard or a portion for mounting the accessories.

Moreover, when a high-grade sense is required, a leather-like interior is offered by providing a seam line portion by sewing in the surface material (refer to Patent Document 1, for example). In this case, it is necessary to cut off the seam line portion along with the surface material when trimming the outside portion of the circumference edge portion of the core material opening portion as described above.

### CITATION LIST

### Patent Literature

Patent Literature 1: JP 2727348B

### SUMMARY

### Technical Problem

However, the structure of the multilayer component has the following problem. Since it is difficult to accurately cut off only the surface material with the cutting tool such as the hot blade when trimming the outside portion of the circumference edge portion of the core material opening portion, the cutting tool such as the hot blade is cut into the core material. That is, a part of the core material may be cut along with the surface material. When a part of the core material is cut, the cut part of the core material is deformed when the accessory is mounted, and alignment surfaces of the vehicle interior component and the accessory are thereby shifted to each other.

Since a machine-sewing thread constituting the seam line is made of heat-resistant polyester, and is obtained by twisting many thin threads, it is very strong and cannot be completely cut off by simply pressing the cutting tool such as the hot blade to the thread.

It requires an additional work to form the opening portion and the concave portion when the seam line portion is provided.

### Solution to Problem

To solve the above problem, the present invention provides a structure of a multilayer component in which a rigid core material, a soft surface material, and a cushioned foam layer provided between the core material and the surface material are integrated, wherein the core material includes an exposed core material portion without having the surface material and the foam layer, the exposed core material portion is obtained by cutting off at least the surface material to be eliminated, and a cutting assist portion that projects toward the surface material or toward an opposite side of the surface material to assist cutting off with a cutting tool is provided in a part of the core material on which the surface material is cut off.

### Advantageous Effects

According to the above configuration of the present invention, the following effects can be obtained.

The cutting assist portion that projects toward the surface material or toward the opposite side of the surface material is provided in the part of the core material on which the surface material 6 is cut off. With this configuration, the cutting off of the surface material with the cutting tool can be assisted by the cutting assist portion. A required strength can be applied to the part of the core material by the cutting assist portion even through the cutting tool cuts into the part of the core material. Thus, the alignment surfaces of the vehicle interior component and the accessory can be prevented from being shifted to each other due to the deformation of the core material even though the accessory is mounted on the exposed core material portion.

The opening portion and the concave portion can be therefore formed in the multilayer component without any difficulty.

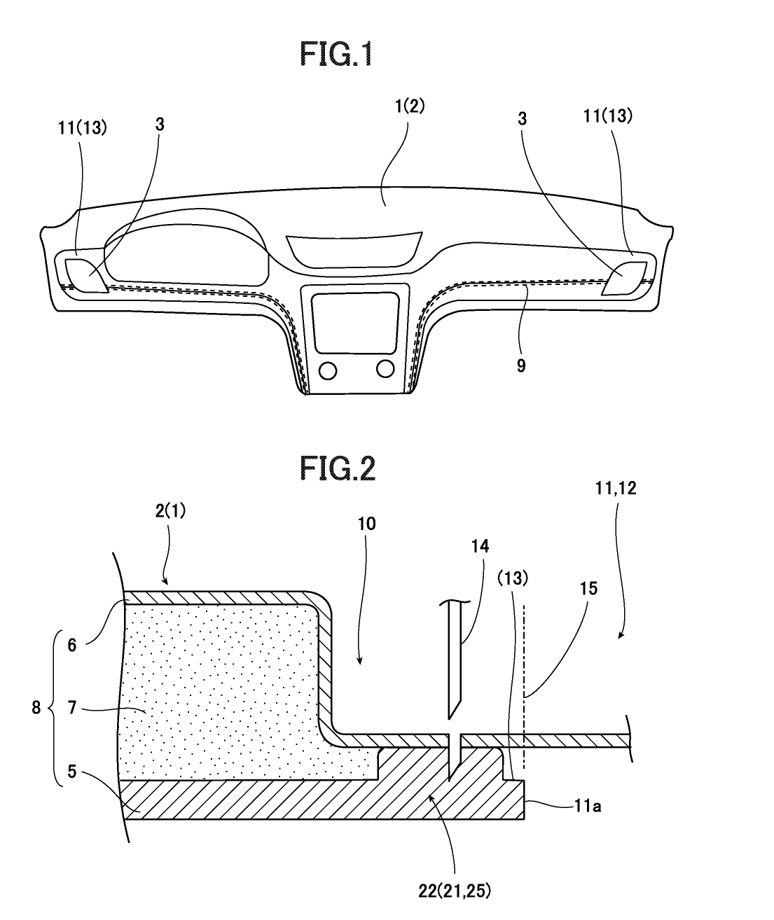

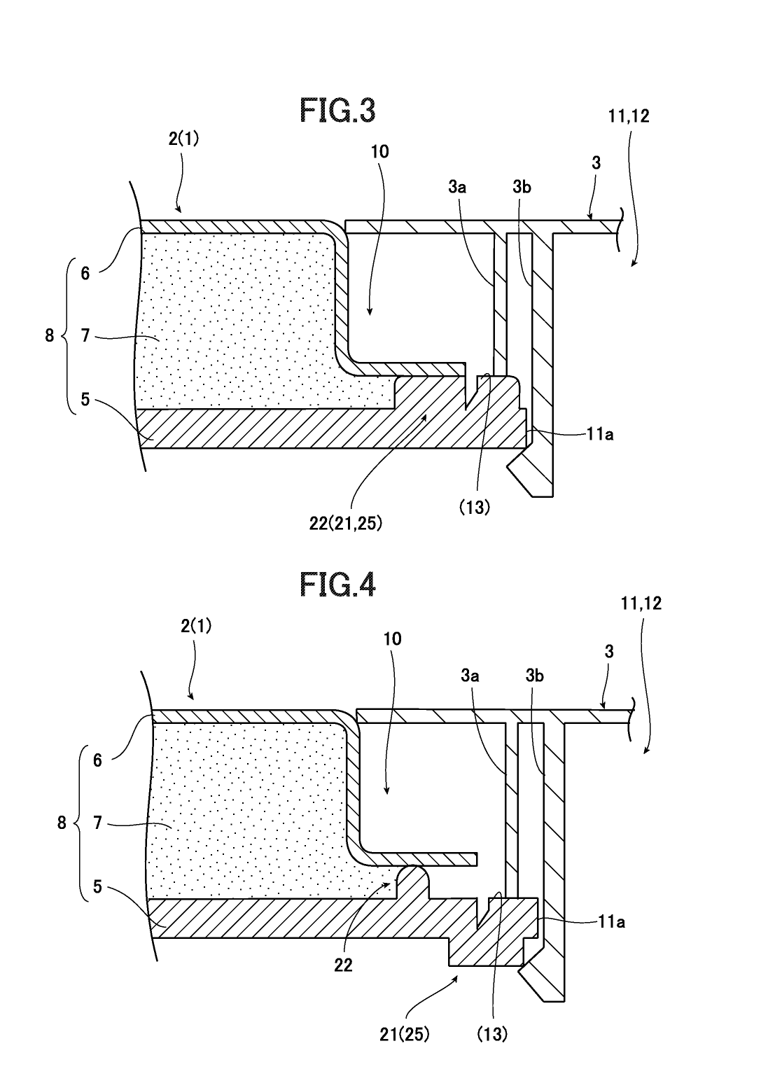

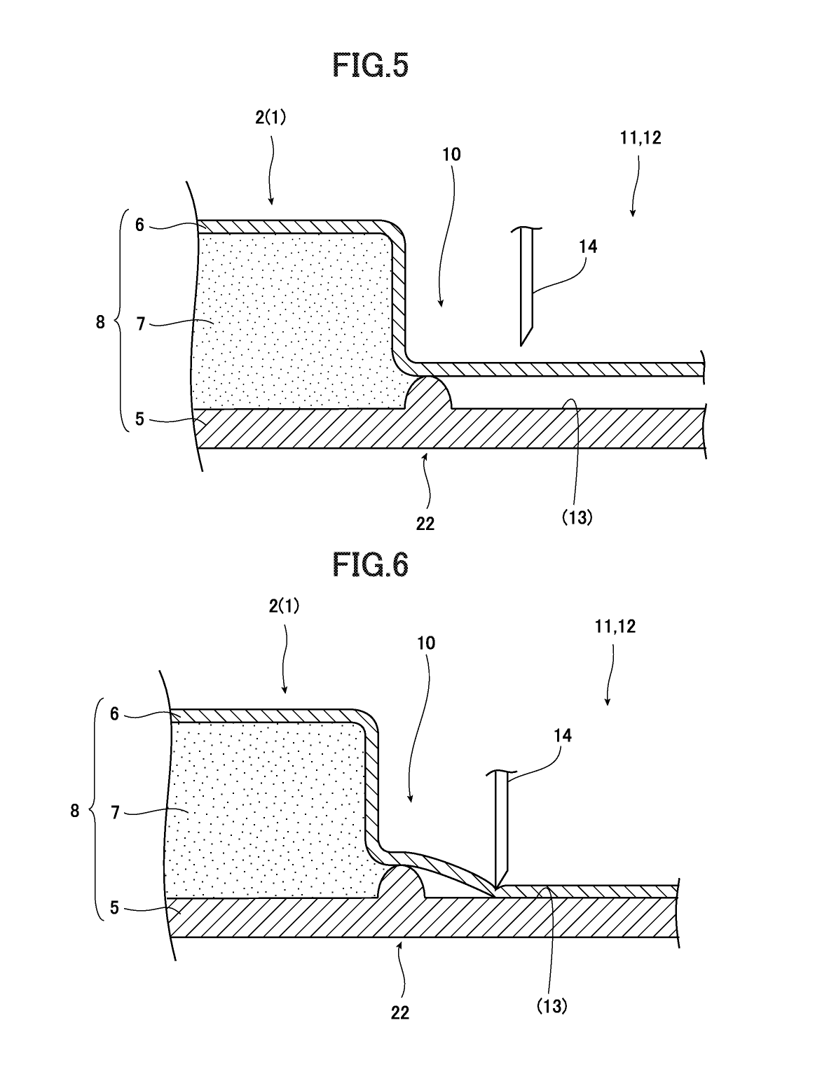

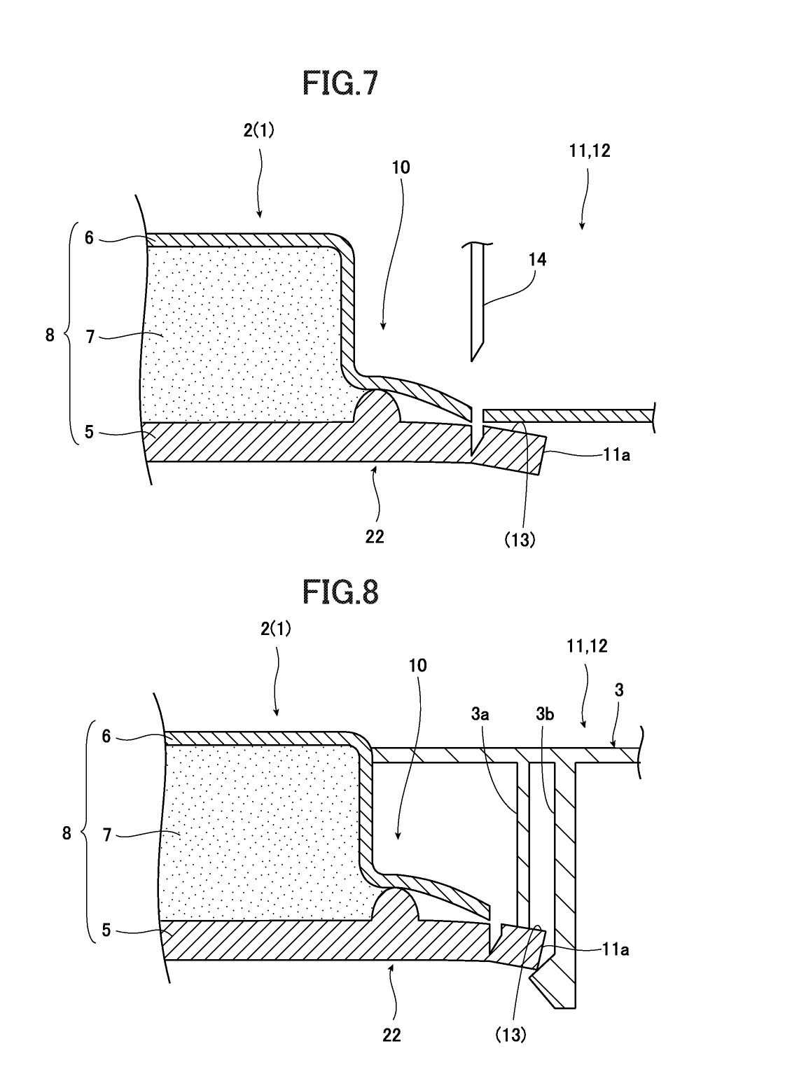

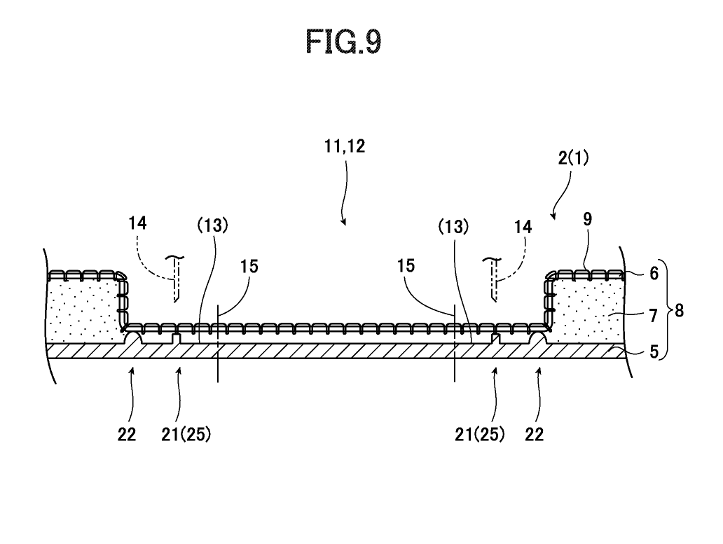

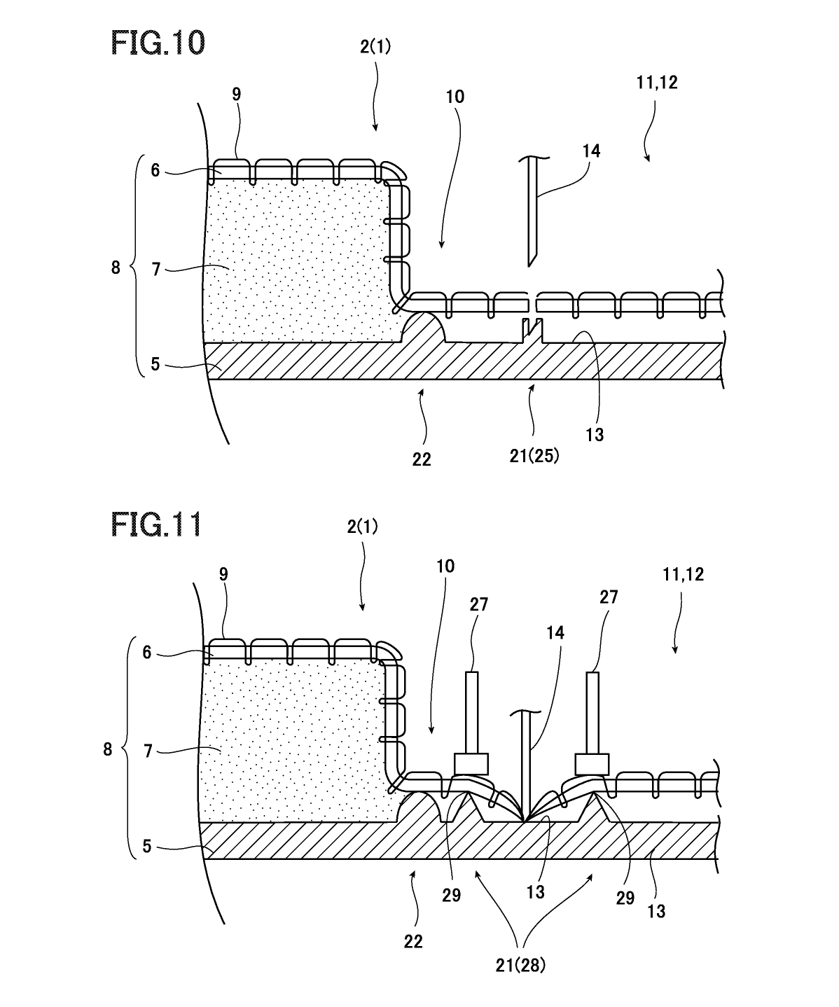

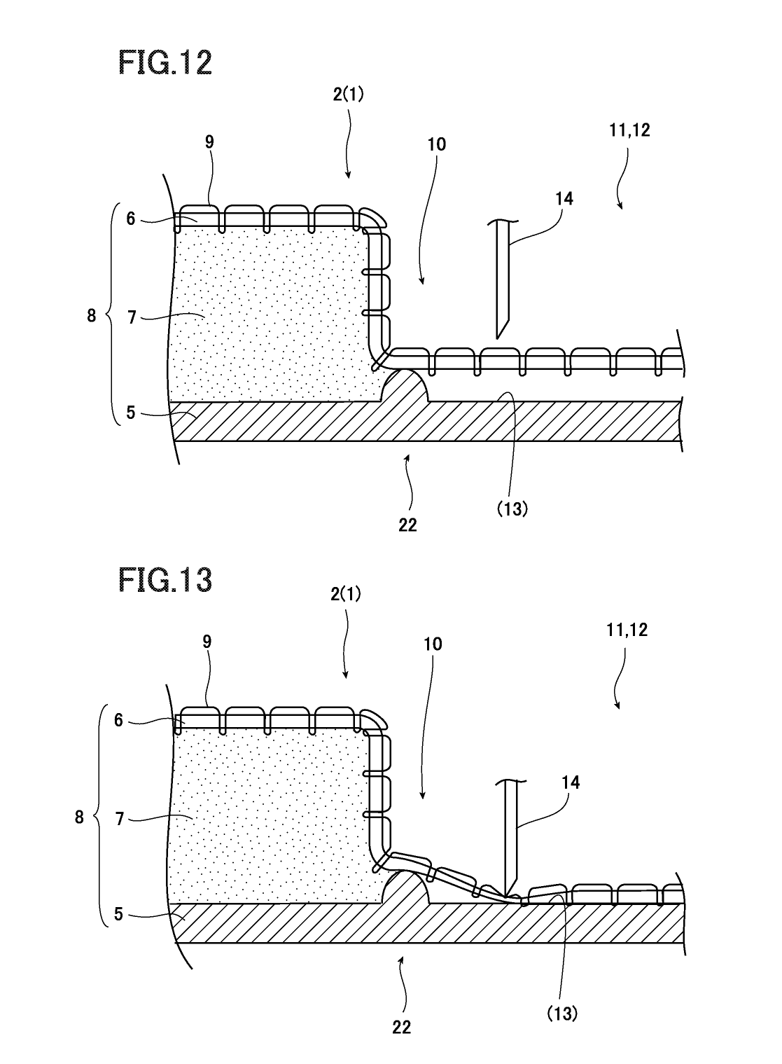

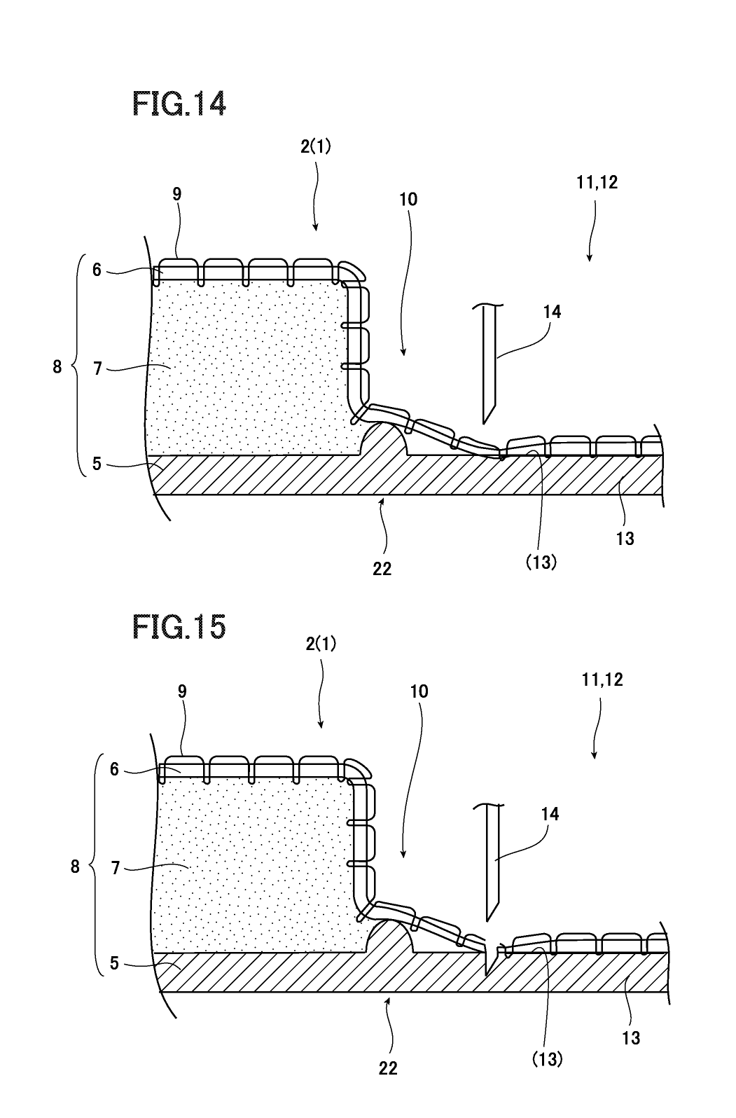

### BRIEF DESCRIPTION OF DRAWINGS

[FIG. 1] FIG. 1 is a front view showing a structure of a multilayer component according to examples described in an embodiment of the present invention,

[FIG. 2] FIG. 2 is a partial enlargement sectional view showing an exposed core material portion in FIG. 1 according to Example 1,

[FIG. 3] FIG. 3 is a partial enlargement sectional view similar to FIG. 2 showing an accessory mounted on the exposed core material portion in FIG. 2,

[FIG. 4] FIG. 4 is a partial enlargement sectional view similar to FIG. 3 according to a modified example of Example 1,

[FIG. 5] FIG. 5 is a partial enlargement sectional view similar to FIG. 2 without having a cutting assist portion,

[FIG. 6] FIG. 6 is an operation view when a surface material in FIG. 5 is cut off,

[FIG. 7] FIG. 7 is an operation view following FIG. 6 when a part of the core material is cut,

[FIG. 8] FIG. 8 is an operation view following FIG. 7 when the accessory is mounted on the exposed core material portion,

[FIG. 9] FIG. 9 is a partial enlargement sectional view showing the exposed core material portion in FIG. 1 according to Example 2,

[FIG. 10] FIG. 10 is a partial enlargement sectional view of FIG. 8,

[FIG. 11] FIG. 11 is a partial enlargement sectional view similar to FIG. 9 according to a modified example of Example 2,

[FIG. 12] FIG. 12 is a partial enlargement sectional view similar to FIG. 9 without having a cutting assist portion,

[FIG. 13] FIG. 13 is an operation view when the surface material and a seam line portion in FIG. 12 are cut off,

[FIG. 14] FIG. 14 is an operation view following FIG. 13 when the seam line portion cannot be cut off, and

[FIG. 15] FIG. 15 is an operation view following FIG. 13 when the exposed core material portion is concaved.

### DESCRIPTION OF EMBODIMENT

Hereinafter, an embodiment and examples of the embodiment of the present invention will be described with reference to the drawings.

FIGS. 1 to 15 are views describing examples and modified examples of the embodiment of the present invention. FIG. 1 is common to each example, FIGS. 2 to 8 relate to Example 1, and FIGS. 9 to 15 relate to Example 2.

As illustrated in FIG. 1, a vehicle interior component 2 such as an instrument panel 1 is installed in a front part of a vehicle interior in a vehicle such as an automobile. Accessories 3 (refer to FIG. 3) for example, a ventilator grill and a decoration panel that are structured as separate members are mounted on the instrument panel 1.

These accessories 3 are mounted on opening portions 11 or concave portions 12 that are previously formed in predetermined positions of the instrument panel 1. Not-shown various vehicle interior components 2 such as a console box are installed in the vehicle interior.

As illustrated in FIG. 2, the vehicle interior component 2 is structured by a multilayer component 8 in which a rigid core material 5, a soft surface material 6, and a cushioned foam layer 7 provided between the rigid core material 5 and the soft surface material 6 are integrated.

The opening potion 11 or the concave portion 12 on which the accessory 3 is mounted is provided in the vehicle interior component 2.

For forming the opening portion 11 or the concave portion 12, an opening and concave portion formation predetermined portion 10 without having the foam layer 7 in a portion where the opening portion 11 or the concave portion 12 is formed, for example, a two-layer laminated portion having the core material 5 and the surface material 6 is formed in foam molding, or an opening and concave portion formation predetermined portion 10 in which a thickness of the foam layer 7 in the portion where the opening portion 11 or the concave portion 12 is formed is thinner than that of the other portion, for example, a three-layer laminated portion having the core material, foam layer, and surface material is formed in the foam molding.

After the foam molding, the inside portion of the opening and concave portion formation predetermined portion 10 is appropriately processed by using a cutting tool 14 such as a hot blade to form an exposed core material portion 13 (refer to FIG. 3).

The accessory 3 is then mounted on the exposed core material portion 13.

More specifically, for forming the opening portion 11, an opening portion, namely, a core material opening portion 11a is formed inside the opening and concave portion formation predetermined portion 10 by penetrating the two-layer laminated portion having the core material 5 and the surface material 6 or the three-layer laminated portion having the core material 5, foam layer 7, and surface material 6 inside the opening and concave portion formation predetermined portion 10 at a cutting off position 15 in FIG. 2 with the cutting tool 14 such as the hot blade.

After that, the exposed core material portion 13 is formed in the circumference of the core material opening portion 11a as illustrated in FIG. 3 by trimming the surface material 6 and the foam layer 7 to leave only the core material 5 with the cutting tool 14 such as the hot blade between an outside of a circumference edge portion of the core material opening portion 11a and an inside of a circumference edge portion of the opening and concave portion formation predetermined portion 10.

For forming the concave portion 12, the opening and concave portion formation predetermined portion 10 without having the foam layer 7 in the portion where the concave portion 12 is formed, for example, the two-layer laminated portion having the core material 5 and the surface material 6 is previously formed in the foam molding. After the foam molding, the exposed core material portion 13 is formed by trimming the surface material 6 (including seam line portion 9) and the like to leave only the core material 5 with the cutting tool 14 such as the hot blade inside the opening and concave portion formation predetermined portion 10.

Supplemental Explanation

Hereinafter, supplemental explanation is given for the above configuration.

The core material 5 is made of rigid resin. The core material 5 has a constant thickness except for an exceptional part.

The surface material 6 is made of soft resin. The surface material has a constant thickness except for an exceptional part.

The foam layer 7 is also referred to as a cushioned layer. The foam layer 7 has a constant thickness except for an exceptional part.

The multilayer component 8 is manufactured by the core material 5, surface material 6, and foam layer 7 provided between the core material 5 and the surface material 6. The foam layer 7 is obtained by injecting foam liquid as the material of the foam layer 7 between the core material 5 and the surface material 6 set in a not-shown mold of a foam molding apparatus, namely, a foam molding die so as to foam the foam liquid in the foam molding die. The foam liquid is obtained by adding foam agent to undiluted solution as the material of the foam layer 7 and adjusting a concentration to be a desired foam ratio. The multilayer component 8 has a constant thickness except for an exceptional part.

The opening and concave portion formation predetermined portion 10 is as follows. At first, a protrusion 22 as a dammed portion is provided on the front surface of the core material 5, namely, the surface facing the surface material 6 to have a loop shape along the shape of the opening and concave portion formation predetermined portion 10. The surface material 6 is pressed against the protrusion 22 in the foam molding to prevent the inside of the loop protrusion 22 from being injected by the foam liquid.

A concave portion having a depth substantially equal to the thickness of the multilayer component 8 is previously formed in the surface material 6 in a position corresponding to the loop protrusion 22 before the foam molding.

The thickness of the outside portion of the opening and concave portion formation predetermined portion 10 becomes therefore equal to the other portion of the multilayer component 8 and the core material 5 is therefore covered by the surface material 6 inside the opening and concave portion formation predetermined portion 10. In this case, for example, the core material 5 and the surface material 6 are separated by the foam layer 7 inside the loop protrusion 22.

A primer for improving an adhesion property of the core material 5 and the foam layer 7 may be applied to the outside portion of the loop protrusion 22 in the core material 5.

The exposed core material portion 13 is provided by trimming the surface material 6 inside the opening and concave portion formation predetermined portion 10 so as to obtain a standard for mounting the accessory 3, namely, an alignment standard when forming the opening portion 11 or the concave portion 12 on which the accessory 3 is mounted in the multilayer component 8.

An air outlet member such as the ventilator grill is mounted on the opening portion 11 as the accessory 3.

A decoration panel such as a finisher or a decoration component such as an emblem is fitted into the concave portion 12 as the accessory 3.

As illustrated in FIG. 3, a supporter 3a or a positioner and a claw 3b are appropriately provided in the rear surface of the accessory 3 that is mounted on the opening portion 11. The supporter 3a or the positioner contacts with the front surface of the exposed core material portion 13 to be supported by the front surface of the exposed core material portion 13. The claw 3b is engageable with the rear surface of the exposed core material portion 13 through the core material opening portion 11a.

The cutting tool 14 is for example the hot blade as described above. The hot blade is obtained by heating a cutting blade with a heater to cut off a resin component without any difficulty.

In addition, the above configuration is common to the following respective examples.

### EXAMPLE 1

Configuration

Hereinafter, the configuration of Example 1 will be described.

FIGS. 1, 2 to 8 are views describing Example 1 and the modified example of the embodiment of the present invention.

Configuration 1

A cutting assist portion 21 that assists the cutting off with the cutting tool 14 is provided in a part of the core material 5 on which the surface material 6 is cut off. The cutting assist portion 21 projects toward the surface material 6 (refer to FIG. 2) or toward the opposite side of the surface material 6 (refer to FIG. 4).

Supplemental Explanation 1

The part of the core material 5 on which the surface material 6 is cut off is a part for trimming the surface material 6 to form the exposed core material portion 13.

The cutting assist portion 21 projects toward the surface material 6 or toward the opposite side of the surface material 6, or the cutting assist portion 21 projects toward both of the surface material 6 and the opposite side of the surface material 6.

The cutting assist portion 21 is provided as a surface material cutting assist portion that assists the cutting off of the surface material 6. The cutting assist portion 21 is also used as a tool receiving portion 25 that directly receives the cutting tool 14. The tool receiving portion 25 is integrated with the core material 5.

The tool receiving portion 25 is formed to have a height in view of a concave portion obtained by the cutting with the cutting tool 14, namely, a portion where a part of the core material 5 is cut. With this tool receiving portion 25, a part of the core material 5 provided with the cutting assist portion 21 has a thickness the same as the constant thickens of the core material 5 or a thickness thicker than the constant thickness.

The apex of the tool receiving portion 25 has a flat surface parallel to the front surface of the core material 5 to reliably receive the cutting tool 14.

More specifically, in FIG. 2, the cutting assist portion 21 is formed to project toward the surface material 6. The cutting assist portion 21 may be separated from the protrusion 22. In this case, the cutting assist portion 21 is integrated with the protrusion 22 to simplify the structure.

Moreover, in FIG. 4, the cutting assist portion 21 is formed to project toward the opposite side of the surface material 6. The cutting assist portion 21 is separated from the protrusion 22.

Configuration 1-2

As described above, the multilayer component 8 is the vehicle interior component 2.

Supplemental Explanation 1-2

The vehicle interior component 2 may be the instrument panel 1 provided in the front part of the vehicle interior or a box lid of a housing such as a glove box provided on a passenger side of the instrument panel 1.

However, the multilayer component 8 can be used for a component except the instrument panel 1 and the box lid of the glove box.

Effect

According to Example 1, the following effects can be obtained.

Effect 1-1

The cutting assist portion 21 that projects toward the surface material 6 or toward the opposite side of the surface material 6 is provided in the part of the core material 5 on which the surface material 6 is cut off. With this configuration, the cutting off of the surface material 6 with the cutting tool 14 can be assisted by the cutting assist portion 21. A required strength can be applied to the part of the core material 5 by the cutting assist portion 21 even through the cutting tool 14 cuts into the part of the core material 5. Thus, the alignment surfaces of the vehicle interior component 2 and the accessory 3 can be prevented from being shifted to each other due to the deformation of the core material 5 even though the accessory 3 is mounted on the exposed core material portion 13.

The opening portion 11 and the concave portion 12 can be therefore formed in the multilayer component 8 without any difficulty.

On the other hand, if the cutting assist portion 21 is not provided in the core material 5, as illustrated in FIGS. 5 to 7, since it is difficult to accurately cut off only the surface material 6 with the cutting tool 14 such as the hot blade, the cutting tool 14 such as the hot blade is cut into the core material 5 when trimming the outside portion of the circumference edge portion of the opening portion 11. Namely, a part of the core material 5 may be cut along with the surface material 6. A required thickness may not be maintained for the core material 5.

When the part of the core material 5 is cut as described above, the cut part of the core material 5 is deformed when mounting the accessory 3, as illustrated in FIG. 8. The alignment surfaces of the vehicle interior component 2 and the accessory 3 are therefore shifted to each other.

Effect 1-2

Since the multilayer component 8 is the vehicle interior component 2, the multilayer component 8 installed in a vehicle can be formed without any difficulty.

### EXAMPLE 2

Configuration

Hereinafter, the configuration of Example 2 will be described.

FIGS. 1, 9 to 15 are views describing Example 2 and the modified example of the embodiment of the present invention.

As the basic configuration illustrated in FIG. 1, a seam line portion 9 is provided in the surface material 6 with a sewing machine to offer a high grade sense, for example, a leather-like sense.

Here, the seam line portion 9 or a stitch portion is made of a polyester sewing thread. Since the polyester sewing thread has a heat-resistant property and is obtained by twisting many thin threads, it is very strong and it is hardly cut off by simply pressing the cutting tool 14 such as the hot blade to the thread. The seam line portion 9 is provided in the surface material 6 to pass through the position of the exposed core material portion 13. When forming the exposed core material portion 13, it is necessary to trim the surface material 6 along with the seam line portion 9.

Configuration 2-1

As illustrated in FIG. 9, the cutting assist portion 21 that projects toward the surface material 6 or toward the opposite side of the surface material 6 to assist the cutting off of the seam line portion 9 with the cutting tool 14 is provided in a part of the core material 5 on which the seam line portion 9 formed in the surface material 6 is cut off.

Supplemental Explanation 2-1

The cutting assist portion 21 projects toward the surface material 6 or toward the opposite side of the surface material 6, or projects toward both of the surface material and the opposite side of the surface material. In this example, the cutting assist portion 21 projects toward the surface material 6.

The cutting assist portion 21 is provided as the surface material cutting assist portion that assists the cutting off of the surface material 6 and the seam line cutting assist portion that assists the seam line portion 9. This cutting assist portion 21 will be described later.

In addition, the cutting assist portion 21 in Example 2 as the seam line cutting assist portion may include the function of the cutting assist portion 21 in Example 1 as the surface material cutting assist portion. The cutting assist portion 21 in Example 2 as the seam line cutting assist portion and the cutting assist portion 21 in Example 1 as the surface material cutting assist portion may be separately provided.

Configuration 2-2

As illustrated in FIG. 10, the cutting assist portion 21 is located to face the cutting tool 14, and is used as the tool receiving portion 25 that directly receives the cutting tool 14.

Supplemental Explanation 2-2

The tool receiving portion 25 projects toward the surface material 6 from a part in which the exposed core material portion 13 is formed so as to have a height in view of a concave portion obtained by the cutting with the cutting tool 14, namely, a portion where a part of the tool receiving portion 25 is cut when cutting off the seam line portion 9 with the cutting tool 14.

After cutting the surface material 6 and the seam line portion 9, the part of the core material 5 provided with the cutting assist portion 21 has a thickness the same as the constant thickens of the core material 5 or a thickness thicker than the constant thickness. The tool receiving portion 25 is integrated with the core material 5. The apex of the tool receiving portion 25 has a flat surface parallel to the front surface of the core material 5 to reliably receive the cutting tool 14.

Configuration 2-3

As illustrated in FIG. 11, the cutting assist portions 21 are provided on both sides of the cutting tool 14 to be opposite to each other across the cutting tool 14. The cutting assist portions 21 are used as a pair of seam line receiving bases 28 that can sandwich and hold two positions of the seam line portion 9 on both sides of the cutting off position of the seam line portion 9 with a pair of external seam line pressing holders 27.

At least one of the seam line receiving bases 28 includes a non-slip portion 29 that prevents the surface material 6 or the seam line portion 9 from being slipped.

Supplemental Explanation 2-3

The external seam line pressing holder 27 is a clamping device that holds at least the circumference of the seam line portion 9 in the surface material 6 when cutting off the surface material 6.

The seam line receiving base 28 has a shape and a size suitable for holding the seam line portion 9 with the clamping device. The interval between a pair of seam line receiving bases 28 is the same as an interval into which the cutting tool 14 can be inserted or an interval slightly wider than that. The seam line receiving base 28 projects toward the surface material 6 from a part in which the exposed core material portion 13 is formed. The seam line receiving base 28 is integrated with the core material 5.

The non-slip portion 29 may be a fine asperity formed on the surface of the seam line receiving base 28 or a non-slip member adhered to the surface of the seam line receiving base 28. In this case, the non-slip portion 29 is obtained by steeping the leading end portion of the seam line receiving base 28.

Configuration 2-4

As described above, the multilayer component 8 is the vehicle interior component 2.

Effect

According to Example 2 the following effects can be obtained.

Effect 2-1

The cutting assist portion 21 that projects toward the surface material 6 or toward the opposite side of the surface material 6 is provided in the part of the core material 5 on which the seam line portion 9 formed in the surface material 6 is cut off. With this configuration, the cutting off of the seam line portion 9 with the cutting tool 14 can be assisted by the cutting assist portion 21.

Even if the seam line portion 9 is hardly cut off, the cutting off failure of the seam line portion 9 is prevented, and the strength of the exposed core material portion 13 is prevented from being decreased due to the concave portion formed in the exposed core material portion 13 with the cutting tool 14.

The opening portion 11 or the concave portion 12 is therefore formed to the multilayer component 8 provided with the seam line portion 9 without any difficulty.

On the other hand, if the cutting assist portion 21 is not provided in the exposed core material portion 13, when the surface material 6 is cut off together with the seam line portion 9 with the cutting tool 14, as illustrated in FIGS. 12 and 13, the seam line portion 9 cannot be cut off, as illustrated in FIG. 14 or the concave portion is formed in the exposed core material portion 13 with the cutting tool 14, as illustrated in FIG. 15. The thickness of the exposed core material portion 13 is partially reduced, resulting in decrease in the strength of the exposed core material portion 13.

Effect 2-2

The cutting assist portion 21 is used as the tool receiving portion 25 located to face the cutting tool 14. With this configuration, the cutting tool 14 can be directly received by the tool receiving portion 25. The surface material 6 and the seam line portion 9 can be thereby directly sandwiched between the cutting tool 14 and the tool receiving portion 25 to be completely cut off.

Here, the cutting tool 14 is cut into the tool receiving portion 25. The tool receiving portion 25 is thereby deformed to have a concave portion. However, the tool receiving portion 25 projects from the exposed core material portion 13 in view of the size of the concave portion, namely, the thickness of the tool receiving portion 25 can be increased. The thickness of base portion of the exposed core material portion 13 is therefore not reduced, and the strength of the exposed core material portion 13 can be prevented from being decreased.

Effect 2-3

As illustrated in FIG. 11, the cutting assist portions 21 are a pair of seam line receiving bases 28 provided on both sides of the cutting tool 14 to be opposite to each other across the cutting tool 14. With this configuration, the two positions of the seam line portion 9 on both sides of the cutting off position of the seam line portion 9 are sandwiched and held between a pair of seam line receiving bases 28 and a pair of seam line pressing holders 27. A tensile force required for cutting off the seam line portion 9 can be applied.

Thus, the surface material 6 and the seam line portion 9 can be completely cut off with the cutting tool 14. In this case, since the seam line portion 9 can be cut off while being separated from the exposed core material portion 13, the thickness of the base portion of the exposed core material portion 13 can be prevented from being reduced and the strength of the exposed core material portion 13 can be prevented from being decreased.

At least one of the seam line receiving bases 28 includes the non-slip portion 29. With this configuration, the surface material 6 and the seam line portion 9 are prevented from being slipped between the seam line receiving bases 28 and the seam line pressing holders 27. Thus, decrease in the above-described tensile force can be prevented.

Effect 2-4

Since the multilayer component 8 is the vehicle interior component 2, the multilayer component 8 having the seam line portion 9 installed in a vehicle can be formed without any difficulty.

Hereinabove, the embodiment of the present invention has been described in detail with reference to the drawings. It should be understood that this embodiment is only illustrative and exemplary of the present invention. The present invention is not intended to be constructed to be limited to the configurations disclosed in the embodiment. Needless to say, variations or modifications should be considered to be included in the present invention without departing from the gist of the present invention. Further, it should be understood that multiple configurations incorporated in the embodiment, for example, can be combined without any particular description. Further, when multiple examples and modified examples are disclosed, combinations of two or more of these examples and modified examples should be considered to be incorporated in the present invention. Moreover, configurations disclosed in the accompanying drawings are naturally considered to be included in the present invention without any particular description. Further, the term, “and/or the like (such as)” is used to indicate that anything equivalent is also include. Also, when the terms such as “substantially”, “about”, and “approximately” are used to indicate that anything within a reasonable range or accuracy are also included.

### CROSS-REFERENCE TO RELATED APPLICATION

The present application is based on and claims priority from Japanese Patent Application No. 2013-036836, filed on Feb. 27, 2013 and Japanese Patent Application No. 2013-139711, filed on Jul. 3, 2013, the disclosures of which are hereby incorporated by reference in their entirety.

1. A structure of a multilayer component in which a rigid core material, a soft surface material, and a cushioned foam layer provided between the core material and the surface material are integrated, wherein
the core material includes an exposed core material portion without having the surface material and the foam layer,
the exposed core material portion is obtained by cutting off at least the surface material to be eliminated, and
a cutting assist portion that projects toward the surface material or toward an opposite side of the surface material to assist cutting off with a cutting tool is provided in a part of the core material on which the surface material is cut off.

2. A structure of a multilayer component in which a rigid core material, a soft surface material, and a cushioned foam layer provided between the core material and the surface material are integrated, wherein
the surface material includes a seam line portion formed by sewing,
the core material includes an exposed core material portion without having the surface material and the foam layer,
the exposed core material portion is obtained by cutting off the surface material along with the seam line portion to be eliminated, and
a cutting assist portion that projects toward the surface material or toward an opposite side of the surface material to assist cutting off of the seam line portion with a cutting tool is provided in a part of the core material on which the seam line portion formed in the surface material is cut off.

3. The structure of the multilayer component according to claim 2, wherein
the cutting assist portion is a tool receiving portion provided in a position facing the cutting tool to directly receive the cutting tool.

4. A structure of a multilayer component in which a rigid core material, a soft surface material, and a cushioned foam layer provided between the core material and the surface material are integrated, wherein
the surface material includes a seam line portion formed by sewing,
the core material includes an exposed core material portion without having the surface material and the foam layer,
the exposed core material portion is obtained by cutting off at least the surface material along with the seam line portion to be eliminated,
the core material is provided with a cutting assist portion that projects toward the surface material to assist cutting off of the seam line portion with a cutting tool,
the cutting assist portion includes a pair of seam line receiving bases provided on both sides of the position facing the cutting tool to sandwich and hold two positions of the seam line portion on both sides of a cutting off position of the seam line portion with an external seam line pressing holder, and
at least one of the seam line receiving bases has a non-slip portion that prevents the surface material or the seam line portion from being slipped.

5. The structure of the multilayer component according to claim 1, wherein the multilayer component is a vehicle interior component.

6. The structure of the multilayer component according to claim 2, wherein the multilayer component is a vehicle interior component.

7. The structure of the multilayer component according to claim 3, wherein the multilayer component is a vehicle interior component.

8. The structure of the multilayer component according to claim 4, wherein the multilayer component is a vehicle interior component.
